(19) United States
(12) Patent Application Publication
(10) Pub. No.: US 2024/0019748 A1
(43) Pub. Date: Jan. 18, 2024

(54) METHOD OF MANUFACTURING ELECTROCHROMIC DISPLAY PANEL AND ELECTROCHROMIC DISPLAY PANEL

(71) Applicants: Huizhou China Star Optoelectronics Display Co., Ltd., Huizhou (CN); TCL China Star Optoelectronics Technology Co., Ltd., Shenzhen (CN)

(72) Inventors: Hangchuan ZHANG, Huizhou (CN); Lixuan CHEN, Shenzhen (CN); Siyang TU, Huizhou (CN)

(73) Assignees: Huizhou China Star Optoelectronics Display Co., Ltd., Huizhou (CN); TCL China Star Optoelectronics Technology Co., Ltd., Shenzhen (CN)

(21) Appl. No.: 17/897,301

(22) Filed: Aug. 29, 2022

(30) Foreign Application Priority Data
Jul. 14, 2022 (CN) 202210834406.4

(51) Int. Cl. G02F 1/1516; G02F 1/155

(52) U.S. Cl. CPC G02F 1/15165; G02F 1/155; G02F 2001/1555; G02F 2001/164

(57) ABSTRACT

Disclosed are a method of manufacturing an electrochromic display panel and an electrochromic display panel. The manufacturing method includes; manufacturing an array substrate, wherein the array substrate includes a base substrate, a driving layer, and a pixel electrode layer that are stacked in sequence, wherein the pixel electrode layer includes a plurality of sub-pixel electrode groups electrically connected to the driving layer; sequentially using the plurality of sub-pixel electrode groups as working electrodes, and forming a plurality of electrochromic layers disposed in one-to-one correspondence with the plurality of sub-pixel electrode groups by electrochemical polymerization. Different electrochromic layers have different display colors. When any one of the plurality of sub-pixel electrode groups is used as the working electrode, the working electrode is applied with a preset positive voltage, and any one of the electrochromic layers is formed on the corresponding working electrode.

### RELATED APPLICATION

This application claims the benefit of priority of Chinese Patent Application No. 202210834406.4 filed on Jul. 14, 2022, the contents of which are incorporated by reference as if fully set forth herein in their entirety.

### TECHNICAL FIELD

The present disclosure relates to the field of display technology, and in particular, to a method of manufacturing an electrochromic display panel and an electrochromic display panel.

### BACKGROUND

Electrochromic (EC) refers to the fact that a material or device can change its forbidden band width or energy level under the control of an external electric field to selectively absorb a continuous spectrum, thus producing reversible changes in optical properties (such as transmittance, absorbance and reflectance) in the visible-infrared-microwave band. Electrochromic materials can display different colors by absorbing or transmitting different bands of visible light, and thereby have the potential to be used as chromogenic materials in display technologies. Most of the electrochromic materials have desirable memory effect, and after colors are changed, optical properties of the electrochromic materials before cutting power off can be maintained, even if no power is supplied. Therefore, devices prepared by using them have low energy consumption and low driving voltage.

There are various types of electrochromic materials, including transition metal oxides, inorganic metal-organic skeleton materials, conductive polymers, and small organic molecules, depending on compositions. Among them, the conductive polymers have the most designable molecular structure. The colors of the polymers can be transformed by changing the conjugated molecular structure, thereby obtaining an electrochromic material capable of displaying a full range of colors. The gray scales of the colors can be changed by selecting a material with a faded state of black (white/transparent) and a colored state of a single color. Because the conductive polymers have the advantages of low energy consumption, full color ranges and adjustable gray scales, how to prepare a display device with the electrochromic conductive polymers has become a research focus in this field.

Studies in the field of electrochromic display and development and synthesis of the materials have been relatively mature. It is reported that electrochromic properties of more than 400 conductive polymers have been studied, and all of conductive polymers theoretically have electrochromic properties based on the principle of discoloration. The conductive polymers have an energy level bandwidth of 3.2 eV-1.6 eV, and have desirable color displaying performance in the visible region. Since 2000, a large number of documents have reported the relationship between the color properties and the molecular configurations of conductive polymers, verified the influence of various preparation methods on the polymer properties, and studied the growth mechanism and film-forming properties of the materials in detail, thereby obtaining film-forming processes and device configurations of several materials. However, a key challenge for the display application of the electrochromic materials lies in the process of forming a pixelation film of the materials. That is, how to uniformly realize the patterning growth of three-primary-color electrochromic materials in a large area has become the key challenge for the electrochromic passive display technology.

### SUMMARY

The present disclosure provides a method of manufacturing an electrochromic display panel and an electrochromic display panel, in which a plurality of electrochromic layers of uniform thickness, large area, pixel-level patterning, and different display colors can be manufactured on an array substrate by electrochemical polymerization, thereby facilitating realization of an electrochromic passive display technology.

The present disclosure provides a method of manufacturing an electrochromic display panel, comprising steps of:
manufacturing an array substrate, wherein the array substrate comprises a base substrate, and a driving layer and a pixel electrode layer sequentially disposed on the base substrate; and the pixel electrode layer comprises a plurality of sub-pixel electrode groups disposed at intervals; and
forming a plurality of electrochromic layers disposed in one-to-one correspondence with the plurality of sub-pixel electrode groups by electrochemical polymerization using each of the plurality of sub-pixel electrode groups as a working electrode in sequence, wherein the electrochromic layers corresponding to different sub-pixel electrode groups have different display colors, and when any one of the plurality of sub-pixel electrode groups is used as the working electrode, a preset positive voltage is applied to the working electrode to form corresponding electrochromic layers on the working electrode.

Optionally, when any one of the plurality of sub-pixel electrode group is used as the working electrode, a preset negative voltage is applied to other sub-pixel electrode groups.

Optionally, the plurality of sub-pixel electrode groups comprise a first sub-pixel electrode group, a second sub-pixel electrode group, and a third sub-pixel electrode group; the plurality of electrochromic layers comprise first electrochromic layers, second electrochromic layers, and third electrochromic layers respectively disposed in one-to-one correspondence with the first sub-pixel electrode group, the second sub-pixel electrode group, and the third sub-pixel electrode group;

a display color of the first electrochromic layers comprises any one of red, green, and blue; a display color of the second electrochromic layers comprises any one of red, green, and blue different from that of the first electrochromic layers; a display color of the third electrochromic layers comprises any one of red, green, and blue different from those of the first electrochromic layers and the second electrochromic layers.

Optionally, the step of forming the plurality of electrochromic layers disposed in one-to-one correspondence with the plurality of sub-pixel electrode groups by electrochemical polymerization using each of the plurality of sub-pixel electrode groups as the working electrode in sequence, comprises following steps:
preparing a first electrolyte, a second electrolyte, and a third electrolyte, wherein the first electrolyte comprises a first electrochromic monomer, the second electrolyte comprises a second electrochromic monomer, and the third electrolyte comprises a third electrochromic monomer;
constructing a first electrode system by using the first sub-pixel electrode group in the array substrate as the working electrode, placing the first electrode system into the first electrolyte, performing a first electrochemical polymerization, and forming the first electrochromic layers on the first sub-pixel electrode group;
constructing a second electrode system by using the second sub-pixel electrode group in the array substrate provided with the first electrochromic layers as the working electrode, placing the second electrode system into the second electrolyte, performing a second electrochemical polymerization, and forming the second electrochromic layers on the second sub-pixel electrode group; and
constructing a third electrode system by using the third sub-pixel electrode group in the array substrate provided with the first electrochromic layers and the second electrochromic layers as the working electrode, placing the third electrode system into the third electrolyte, performing a third electrochemical polymerization, and forming the third electrochromic layers on the third sub-pixel electrode group.

Optionally, any one of the first electrode system, the second electrode system, and the third electrode system comprises a three-electrode system, and the three-electrode system comprises the working electrode, a counter electrode, and a reference electrode;
the counter electrode comprises any one of a gold electrode, a silver electrode, a platinum electrode, and an indium tin oxide electrode; the reference electrode comprises any one of a silver-silver chloride electrode and a calomel electrode.

Optionally, a material of any one of the first electrochromic monomer, the second electrochromic monomer, and the third electrochromic monomer comprises at least one of derivatives and analogues of any one of aniline, pyrrole, pyridine, anthraquinone, styrene, pyran, oxazine, thiophene, thiopyran, triphenylamine, pyrazoline, phenazine, and phenoxazine.

Optionally, the electrochromic display panel has a display region and a non-display region adjacent to the display region; the pixel electrode layer is located in the display region;
the driving layer comprises a first connection wiring group, a second connection wiring group, and a third connection wiring group located in the display region, and a first voltage-applying terminal, a second voltage-applying terminal, and a third voltage-applying terminal located in the non-display region; the first connection wiring group is electrically connected to the first sub-pixel electrode group, and extends to the non-display region to electrically connect to the first power-on terminal; the second connection wiring group is electrically connected to the second sub-pixel electrode group, and extends to the non-display region to electrically connect to the second power-on terminal; the third connection wiring group is electrically connected to the third sub-pixel electrode group, and extends to the non-display region to electrically connect to the third power-on terminal; and
any one of the first voltage-applying terminal, the second voltage-applying terminal, and the third voltage-applying terminal is applied with the preset positive voltage.

Optionally, the first sub-pixel electrode group comprises a plurality of first sub-pixel electrodes arranged in multiple columns; the second sub-pixel electrode group comprises a plurality of second sub-pixel electrodes arranged in multiple columns; the third sub-pixel electrode group comprises a plurality of third sub-pixel electrodes arranged in multiple columns; and
the first connection wiring group comprises a plurality of first source lines electrically connected in one-to-one correspondence with the multiple columns of the first sub-pixel electrodes; the second connection wiring group comprises a plurality of second source lines electrically connected in one-to-one correspondence with the multiple columns of the second sub-pixel electrodes; the third connection wiring group comprises a plurality of third source lines electrically connected in one-to-one correspondence with the multiple columns of the third sub-pixel electrodes.

Optionally, the driving layer further comprises a plurality of thin film transistors located in the display region and electrically connected in one-to-one correspondence with the plurality of first sub-pixel electrodes, the plurality of second sub-pixel electrodes, and the plurality of third sub-pixel electrodes;
source electrodes of the thin film transistors electrically connected to the first sub-pixel electrodes are electrically connected to the corresponding first source lines, source electrodes of the thin film transistors electrically connected to the second sub-pixel electrodes are electrically connected to the corresponding second source lines, and source electrodes of the thin film transistors electrically connected to the third sub-pixel electrodes are electrically connected to the corresponding third source lines; and
the first voltage-applying terminal, the second voltage-applying terminal, and the third voltage-applying terminal are disposed in a same layer and of same materials as gate electrodes of the thin film transistors.

The present disclosure further provides an electrochromic display panel manufactured by the method described above, comprising:
an array substrate, wherein the array substrate comprises a base substrate, and a driving layer and a pixel electrode layer sequentially disposed on the base substrate; and the pixel electrode layer comprises a plurality of sub-pixel electrode groups disposed at intervals and electrically connected to the driving layer; and
a plurality of electrochromic layers disposed in one-to-one correspondence with the plurality of sub-pixel electrode groups, wherein the plurality of electrochromic layers are formed by electrochemical polymerization using each of the plurality of sub-pixel electrode groups as a working electrode in sequence, wherein the electrochromic layers corresponding to different sub-pixel electrode groups have different display colors, and when any one of the plurality of sub-pixel electrode groups is used as the working electrode, a preset positive voltage is applied to the working electrode to form corresponding electrochromic layers on the working electrode.

Optionally, when any one of the plurality of sub-pixel electrode groups is used as the working electrode, a preset negative voltage is applied to other sub-pixel electrode groups.

Optionally, the plurality of sub-pixel electrode groups comprise a first sub-pixel electrode group, a second sub-pixel electrode group, and a third sub-pixel electrode group; the plurality of electrochromic layers comprise first electrochromic layers, second electrochromic layers, and third electrochromic layers respectively disposed in one-to-one correspondence with the first sub-pixel electrode group, the second sub-pixel electrode group, and the third sub-pixel electrode group;
a display color of the first electrochromic layers comprises any one of red, green, and blue; a display color of the second electrochromic layers comprises any one of red, green, and blue different from that of the first electrochromic layers; a display color of the third electrochromic layers comprises any one of red, green, and blue different from those of the first electrochromic layers and the second electrochromic layers.

Optionally, the first electrochromic layers comprises polymers of a first electrochromic monomer, the second electrochromic layers comprises polymers of a second electrochromic monomer, and the first electrochromic layers comprises polymers of a third electrochromic monomer.

Optionally, a material of any one of the first electrochromic monomer, the second electrochromic monomer, and the third electrochromic monomer comprises at least one of homopolymers of aniline, pyrrole, pyridine, anthraquinone, styrene, pyran, oxazine, thiophene, thiopyran, triphenylamine, pyrazoline, phenazine, and phenoxazine, a derivative or an analogue of the homopolymers, and a copolymer of two or more of aniline, pyrrole, pyridine, anthraquinone, styrene, pyran, oxazine, thiophene, thiopyran, triphenylamine, pyrazoline, phenazine, and phenoxazine.

Optionally, the electrochromic display panel has a display region and a non-display region adjacent to the display region; the pixel electrode layer is located in the display region;
the driving layer comprises a first connection wiring group, a second connection wiring group, and a third connection wiring group located in the display region, and a first voltage-applying terminal, a second voltage-applying terminal, and a third voltage-applying terminal located in the non-display region; the first connection wiring group is electrically connected to the first sub-pixel electrode group, and extends to the non-display region to electrically connect to the first power-on terminal; the second connection wiring group is electrically connected to the second sub-pixel electrode group, and extends to the non-display region to electrically connect to the second power-on terminal; the third connection wiring group is electrically connected to the third sub-pixel electrode group, and extends to the non-display region to electrically connect to the third power-on terminal; and
any one of the first voltage-applying terminal, the second voltage-applying terminal, and the third voltage-applying terminal is applied with the preset positive voltage.

Optionally, the first sub-pixel electrode group comprises a plurality of first sub-pixel electrodes arranged in multiple columns; the second sub-pixel electrode group comprises a plurality of second sub-pixel electrodes arranged in multiple columns; the third sub-pixel electrode group comprises a plurality of third sub-pixel electrodes arranged in multiple columns; and the first connection wiring group comprises a plurality of first source lines
electrically connected in one-to-one correspondence with the multiple columns of the first sub-pixel electrodes; the second connection wiring group comprises a plurality of second source lines electrically connected in one-to-one correspondence with the multiple columns of the second sub-pixel electrodes; the third connection wiring group comprises a plurality of third source lines electrically connected in one-to-one correspondence with the multiple columns of the third sub-pixel electrodes.

Optionally, the driving layer further comprises a plurality of thin film transistors located in the display region and electrically connected in one-to-one correspondence with the plurality of first sub-pixel electrodes, the plurality of second sub-pixel electrodes, and the plurality of third sub-pixel electrodes;
source electrodes of the thin film transistors electrically connected to the first sub-pixel electrodes are electrically connected to the corresponding first source lines, source electrodes of the thin film transistors electrically connected to the corresponding second sub-pixel electrodes are electrically connected to the second source lines, and source electrodes of the thin film transistors electrically connected to the corresponding third sub-pixel electrodes are electrically connected to the third source lines; and
the first voltage-applying terminal, the second voltage-applying terminal, and the third voltage-applying terminal are disposed in a same layer and of same materials as gate electrodes of the thin film transistors.

Optionally, the electrochromic display panel further comprising an opposing substrate on sides of the plurality of electrochromic layers away from the array substrate.

The present disclosure provides the method of manufacturing the electrochromic display panel and the electrochromic display panel, in which the plurality of electrochromic layers with different display colors are formed on the plurality of sub-pixel electrode groups in the array substrate by electrochemical polymerization sequentially and disposed in one-to-one correspondence with the plurality of sub-pixel electrode groups. In one aspect, the present disclosure can produce electrochromic layers with uniform thickness, large area, and pixel-level patterning and different display colors by electrochemical polymerization. Moreover, the electrochemical polymerization is adapted to the array substrate structure of the present disclosure. That is, the monochromatic sub-pixel electrode group in the array substrate may directly be subjected to a corresponding monochromatic electrochromic layer deposition, thereby achieving the advantages of high process matching capacity and reducing the preparing steps. Moreover, due to the relatively strong ability of the polymers to grow in a predetermined region, an electrochromic display panel with high PPI can be advantageously prepared. Furthermore, the electrochromic layers with different display colors can be subjected to ON/OFF control and gray scale control by the driving layer of the array substrate, thereby realizing the electrochromic passive display technology.

### BRIEF DESCRIPTION OF THE DRAWINGS

Technical solutions and other beneficial effects of the present disclosure will be apparent from the following detailed description of specific embodiments of the present disclosure, with reference to the accompanying drawings.

FIG. 1 is a schematic flowchart of a method of manufacturing an electrochromic display panel according to an embodiment of the present disclosure.

FIG. 2 is a schematic view of a partial cross-sectional structure of an array substrate according to an embodiment of the present disclosure.

FIG. 3 is a schematic view of a partial structure of a driving layer of an array substrate according to an embodiment of the present disclosure.

FIG. 4 is a schematic view of the distribution of a pixel electrode layer and source lines corresponding to the region C in FIG. 3.

FIG. 5 is a flowchart structural view of forming first electrochromic layers in a method of manufacturing an electrochromic display panel according to an embodiment of the present disclosure.

FIG. 6 is a flow structural view of forming second electrochromic layers in a method of manufacturing an electrochromic display panel according to an embodiment of the present disclosure.

FIG. 7 is a flow structural view of forming third electrochromic layers in a method of manufacturing an electrochromic display panel according to an embodiment of the present disclosure.

FIG. 8 is a schematic structural view of an electrochromic display panel manufactured by a method of manufacturing an electrochromic display panel according to an embodiment of the present disclosure.

### DETAILED DESCRIPTION OF THE EMBODIMENTS

Technical solutions in the embodiments of the present disclosure will be clearly and completely described with reference to the accompanying drawings in the embodiments of the present disclosure. It will be apparent that the described embodiments are only part of the examples of the present disclosure, and not all examples. Based on the embodiments in the present disclosure, all other embodiments obtained by a person skilled in the art without involving any inventive effort are within the scope of the present disclosure.

In the description of the present disclosure, it should be understood that orientations or position relationships indicated by the terms for example “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, and “counter-clockwise” are based on orientations or position relationships illustrated in the drawings. The terms are used to facilitate and simplify the description of the present disclosure, rather than indicate or imply that the devices or elements referred to herein are required to have specific orientations or be constructed or operate in the specific orientations. Accordingly, the terms should not be construed as limiting the present disclosure. In addition, the term “first”, “second” are for illustrative purposes only and are not to be construed as indicating or imposing a relative importance or implicitly indicating the number of technical features indicated. Thus, a feature that limited by “first”, “second” may expressly or implicitly include one or more the features. In the description of the present disclosure, the meaning of “plural” is two or more, unless otherwise specifically defined.

In the description of the present disclosure, it should be noted that unless otherwise clearly defined and limited, the terms “mounted”, “connected/coupled”, and “connection” should be interpreted broadly. For example, the terms may refer to a fixed connection, a detachable connection, or an integral connection. Alternatively, the terms may also refer to a mechanical connection, an electrical connection, or communication with each other. Alternatively, the terms may further refer to a direct connection, an indirect connection through an intermediary, or an interconnection between two elements or interactive relationship between two elements. Those skilled in the art can understand the specific meanings of the above-mentioned terms in the present disclosure according to circumstances.

In the present disclosure, it should be noted that unless otherwise clearly defined and limited, a first feature “on” or “under” a second feature may mean that the first feature directly contacts the second feature, or that the first feature contacts the second feature via an additional feature therebetween instead of directly contacting the second feature. Moreover, the first feature “on”, “above”, and “over” the second feature may mean that the first feature is right over or obliquely upward over the second feature or mean that the first feature has a horizontal height higher than that of the second feature. The first feature “under”, “below”, and “beneath” the second feature may mean that the first feature is right beneath or obliquely downward beneath the second feature or mean that that horizontal height of the first feature is lower than that of the second feature.

The following description provides various embodiments or examples for implementing various structures of the present disclosure. To simplify the description of the present disclosure, parts and settings of specific examples are described as follows. Certainly, they are only illustrative, and are not intended to limit the present disclosure. Further, reference numerals and reference letters may be repeated in different examples. This repetition is for purposes of simplicity and clarity and does not indicate a relationship of the various embodiments and/or the settings. Furthermore, the present disclosure provides specific examples of various processes and materials. However, those skilled in the art may appreciate applications of other processes and/or other materials.

Electrochemical polymerization generally refers to a process in which ions/particles are grown (deposited) onto an electrode surface under the presence of an electric field to form a thin film. During the deposition process, factors, such as charges and concentrations of the ions, a viscosity of an electrolyte, electroconductibility of electrodes, and the strength and manners of the applied electric field, affect uniformity, thickness, and functional characteristics of the finished film. A process of polymerizing monomers into polymers in the electrolyte and growing on the electrodes is the electrochemical polymerization process, which is similar to the electrodeposition process. TFT (Thin Film Transistor) array substrate can separately supply voltage/current to each sub-pixel electrode (e.g., ITO, Indium Tin Oxide), and the growth of polymer films on a working electrode using voltage/current with different parameters is a common method of the electrochemical polymerization process. Electrochemical polymerization process has a high process matching degree with the patterned TFT array substrate. That is, each sub-pixel electrode can be used as the working electrode, and the voltage/current of the sub-pixel electrode can be adjusted by the TFT in the TFT array substrate to adjust the parameters of polymerization reaction, thereby forming a corresponding sub-pixel on the sub-pixel electrode.

Based on this, the present disclosure proposes to sequentially grow polymers on ITO electrodes (sub-pixel electrodes) of a RGB sub-pixel region in the TFT array substrate, by using electrochemical polymerization in an electrolyte containing electrochromic (EC) monomers displaying R color, in an electrolyte containing EC monomers displaying G color, and an electrolyte containing EC monomers displaying B color, respectively, thereby finally obtaining patterned EC layers for displaying RGB colors on the TFT array substrate. Reference is made in particular to the description in the following examples.

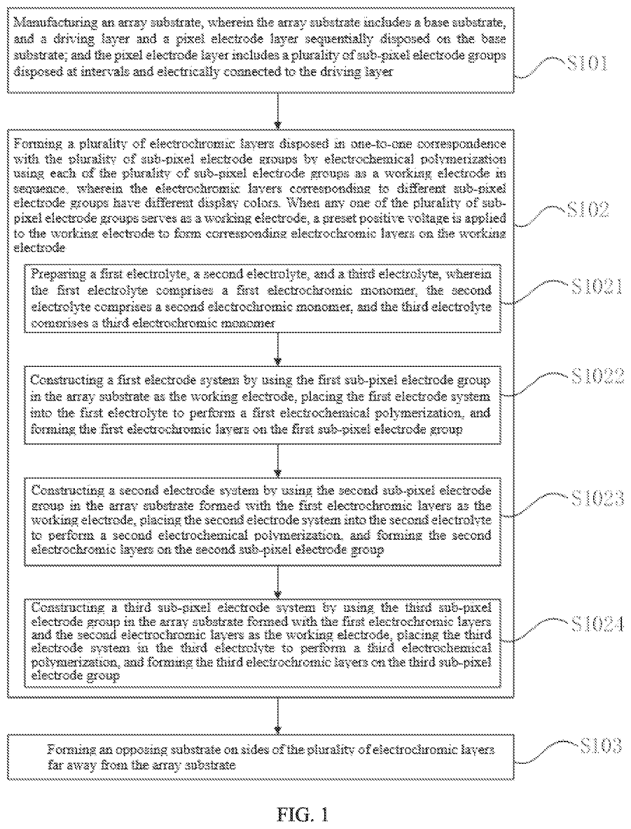

As shown in FIG. 1, an embodiment of the present disclosure provides a method of manufacturing an electrochromic display panel, including steps S101 to S103.

Step S101: Manufacturing an array substrate, wherein the array substrate includes a base substrate, and a driving layer and a pixel electrode layer sequentially disposed on the base substrate; and the pixel electrode layer includes a plurality of sub-pixel electrode groups disposed at intervals and electrically connected to the driving layer.

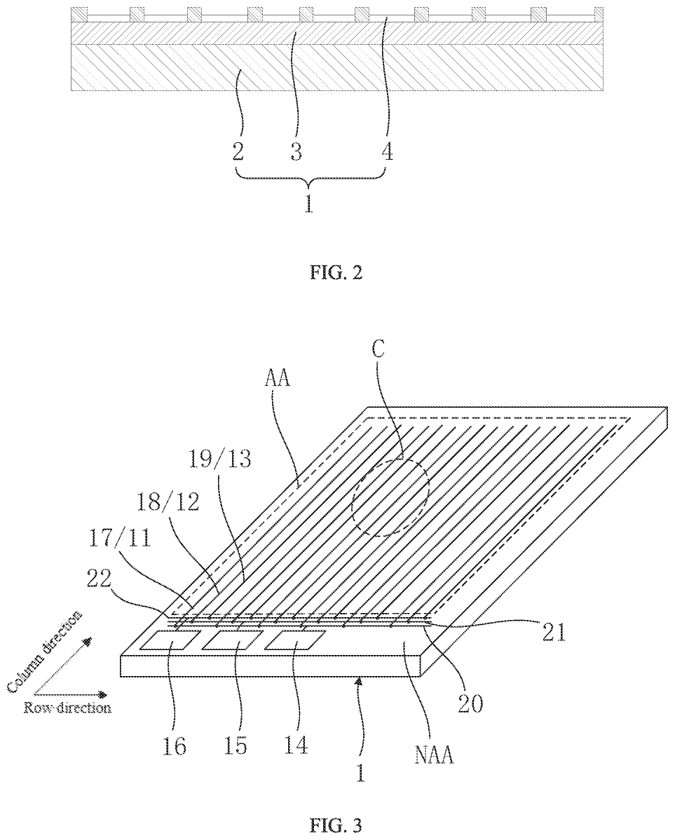

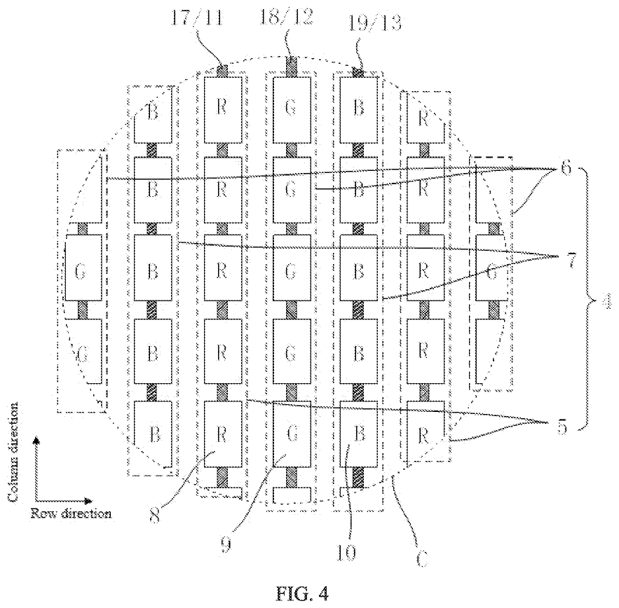

As shown in FIG. 2, the array substrate 1 includes the base substrate 2, and the driving layer 3 and the pixel electrode layer 4 sequentially disposed on the base substrate 2. As shown in FIG. 4, the pixel electrode layer 4 includes the plurality of sub-pixel electrode groups disposed at intervals, for example, a first sub-pixel electrode group 5, a second sub-pixel electrode group 6, and a third sub-pixel electrode group 7. The first sub-pixel electrode group 5 includes a plurality of first sub-pixel electrodes 8, the second sub-pixel electrode group 6 includes a plurality of second sub-pixel electrodes 9, and the third sub-pixel electrode group 7 includes a plurality of third sub-pixel electrodes 10.

It is to be noted that, the plurality of first sub-pixel electrodes 8 in the first sub-pixel electrode group 5 are used to form sub-pixels for displaying the same color. The plurality of second sub-pixel electrodes 9 in the second sub-pixel electrode group 6 are used to form sub-pixels for displaying the same color. The plurality of third sub-pixel electrodes 10 in the third sub-pixel electrode group 7 are used to form sub-pixels for displaying the same color. Further, the sub-pixels respectively formed on the three sub-pixel electrode groups have different display colors. For example, sub-pixels for displaying red (R) are formed on the first sub-pixel electrodes 8, sub-pixels for displaying green (G) are formed on the second sub-pixel electrodes 9, and sub-pixels for displaying blue (B) are formed on the third sub-pixel electrodes 10.

Specifically, materials of the first sub-pixel electrodes 8, the second sub-pixel electrodes 9, and the third sub-pixel electrodes 10 include, but are not limited to, ITO.

In one embodiment, as shown in FIG. 4, the plurality of first sub-pixel electrodes 8, the plurality of second sub-pixel electrodes 9, and the plurality of third sub-pixel electrodes are arranged in an array, for example, in multiple rows or multiple columns. The plurality of first sub-pixel electrodes 8 are arranged in multiple columns, the plurality of second sub-pixel electrodes 9 are arranged in multiple columns, and the plurality of third sub-pixel electrodes 10 are arranged in multiple columns. Further, any one column of the first sub-pixel electrodes 8 is arranged adjacent to one column of the second sub-pixel electrodes 9 and one column of the third sub-pixel electrodes 10. It is to be understood that the multiple columns of first sub-pixel electrodes 8, the multiple columns of second sub-pixel electrodes 9, and the multiple columns of third sub-pixel electrode 10 are arranged side-by-side in a row direction.

Specifically, as shown in FIG. 3, the array substrate 1 is divided into a display region AA and a non-display region NAA adjacent to the display region AA. The pixel electrode layer is located in the display region AA. It is to be noted that the display region AA of the array substrate 1 overlaps a display region of the manufactured electrochromic display panel, and the non-display region NAA of the array substrate 1 overlaps a non-display region of the manufactured electrochromic display panel.

Specifically, as shown in FIGS. 3 and 4, the driving layer includes a first connection wiring group 11, a second connection wiring group 12, and a third connection wiring group 13 located in the display region AA, and a first voltage-applying terminal 14, a second voltage-applying terminal 15, and a third voltage-applying terminal 16 located in the non-display region NAA. The first connection wiring group 11 is electrically connected to the first sub-pixel electrode group 5, and extends to the non-display region NAA to be electrically connected to the first voltage-applying terminal 14. The second connection wiring group 12 is electrically connected to the second sub-pixel electrode group 6, and extends to the non-display region NAA to be electrically connected to the second voltage-applying terminal 15. The third connection wiring group 13 is electrically connected to the third sub-pixel electrode group 7, and extends to the non-display region NAA to be electrically connected to the third voltage-applying terminal 16.

Specifically, a preset positive voltage and/or a preset negative voltage is applied to any one of the first voltage-applying terminal 14, the second voltage-applying terminal 15, and the third voltage-applying terminal 16, so that the preset positive voltage and/or the preset negative voltage is applied to a corresponding sub-pixel electrode group.

In one embodiment, as shown in FIGS. 3 and 4, the first connection wiring group 11 includes a plurality of first source lines 17 electrically connected in one-to-one correspondence with the multiple columns of first sub-pixel electrodes 8. The second connection wiring group 12 includes a plurality of second source lines 18 electrically connected in one-to-one correspondence with the multiple columns of second sub-pixel electrodes 9. The third connection wiring group 13 includes a plurality of third source lines 19 electrically connected in one-to-one correspondence with the multiple columns of third sub-pixel electrodes 10.

In one embodiment, each of the first source lines 17 corresponds to one column of the first sub-pixel electrodes 8, each of the second source lines 18 corresponds to one column of the second sub-pixel electrodes 9, and each of the third source line 19 corresponds to one column of the third sub-pixel electrodes 10.

It is to be understood that, in designing the array substrate 1, the first source lines 17 corresponding to all columns of the first sub-pixel electrodes 8 are led out and connected to the first voltage-applying terminal 14, the second source lines 18 corresponding to all columns of the second sub-pixel electrodes 9 are led out and connected to the second voltage-applying terminal 15, and the third source lines 19 corresponding to all columns of the third sub-pixel electrodes 10 are led out and connected to the third voltage-applying terminal 16.

Specifically, the driving layer further includes a plurality of thin film transistors (TFTs) located in the display region and electrically connected in one-to-one correspondence with the plurality of first sub-pixel electrodes, the plurality of second sub-pixel electrodes, and the plurality of second sub-pixel electrodes. Each of the thin film transistors includes a source electrode, a drain electrode, and a gate electrode. The drain electrodes of the thin film transistors are electrically connected to the corresponding sub-pixel electrodes. The source electrodes of the thin film transistors electrically connected to the first sub-pixel electrodes are electrically connected to the corresponding first source lines, the source electrodes of the thin film transistors electrically connected to the second sub-pixel electrodes are electrically connected to the corresponding second source lines, and the source electrodes of the thin film transistors electrically connected to the third sub-pixel electrodes are electrically connected to the corresponding the third source lines. When the gate electrodes of the thin film transistors are turned on, the source electrodes are communicated with the drain electrodes, so that the source lines are electrically connected to the corresponding sub-pixel electrodes, and thus the sub-pixel electrodes are electrically connected to the corresponding voltage-applying terminal.

It is to be understood that the first source lines, the second source lines, and the third source lines may transmit the preset positive voltage and/or the preset negative voltage to the first sub-pixel electrodes, the second sub-pixel electrodes, and the third sub-pixel electrodes, respectively; or transmit a source electrical signal for displaying to the first sub-pixel electrodes, the second sub-pixel electrodes, and the third sub-pixel electrodes, respectively.

In one embodiment, as shown in FIG. 3, the first voltage-applying terminal 14, the second voltage-applying terminal 15, and the third voltage-applying terminal 16 are arranged at intervals in a row direction. The driving layer further includes a first connection line 20, a second connection line 21, and a third connection line 22 located in the non-display region NAA and located on sides of the first voltage-applying terminal 14, the second voltage-applying terminal 15, and the third voltage-applying terminal 16 adjacent to the display region AA. The first connection line 20, the second connection line 21, and the third connection line 22 are arranged side-by-side in a column direction and extend in the row direction. The plurality of first source lines 17 are connected to the first connection lines 20, the plurality of second source lines 18 are connected to the second connection lines 21, and the plurality of third source lines 19 are connected to the third connection lines 22. The first voltage-applying terminal 14 is connected to the first connection line 20, the second voltage-applying terminal 15 is connected to the second connection line 21, and the third voltage-applying terminal 16 is connected to the third connection line 22.

Specifically, the first voltage-applying terminal 14, the second voltage-applying terminal 15, and the third voltage-applying terminal 16 are disposed in a same layer as and of a same material as the gate electrodes of the thin film transistors. That is, the first voltage-applying terminal 14, the second voltage-applying terminal 15, and the third voltage-applying terminal 16 are formed by a same photolithographic process as the gate electrodes.

The gate electrodes are disposed in a different layer from the source electrodes and the drain electrodes. For example, the gate electrodes are located in a first metal layer, and the source electrodes and the drain electrodes are located in a second metal layer, so that the first voltage-applying terminal 14, the second voltage-applying terminal 15 and the third voltage-applying terminal 16 are located in the first metal layer. The source lines are generally arranged in the same layer as the source electrodes and the drain electrodes, so that the first source lines 17, the second source lines 18 and the third source lines 19 are located in the second metal layer. The first connection line 20, the second connection line 21 and the third connection line 22 may be disposed in the first metal layer or the second metal layer. When the first connection line 20, the second connection line 21, and the third connection line 22 are disposed in the first metal layer, at least two of the first voltage-applying terminal 14, the second voltage-applying terminal 15, and the third voltage-applying terminal 16 are electrically connected to the corresponding connection lines by spanning wire lines, and the first source lines 17, the second source lines 18, and the third source lines 19 are electrically connected to the corresponding first connection line 20, the second connection line 21, and the third connection line 22 through vias. When the first connection line 20, the second connection line 21, and the third connection line 22 are disposed in the second metal layer, at least two of the first source lines 17, the second source lines 18, and the third source lines 19 are electrically connected to the corresponding connection lines by spanning wire lines, and the first voltage-applying terminal 14, the second voltage-applying terminal 15, and the third voltage-applying terminal 16 are electrically connected to the first connection line 20, the second connection line 21, and the third connection line 22 through vias.

Specifically, the minimum distance between any two adjacent voltage-applying terminals of the first voltage-applying terminal 14, the second voltage-applying terminal 15, and the third voltage-applying terminal 16 ranges from 1 mm to 100 mm to ensure electrical insulation between them. The first voltage-applying terminal 14, the second voltage-applying terminal 15, and the third voltage-applying terminal 16 have good electrical conductivity with the display region AA, and have a resistance ranging from 1Ω to 100Ω.

Step S102: Forming a plurality of electrochromic layers disposed in one-to-one correspondence with the plurality of sub-pixel electrode groups by electrochemical polymerization using each of the plurality of sub-pixel electrode groups as a working electrode in sequence, wherein the electrochromic layers corresponding to different sub-pixel electrode groups have different display colors. When any one of the plurality of sub-pixel electrode groups serves as the working electrode, the preset positive voltage is applied to the working electrode to form corresponding electrochromic layers on the working electrode.

Specifically, the plurality of electrochromic layers include first electrochromic layers, the second electrochromic layers, and the third electrochromic layers disposed in one-to-one correspondence with the first sub-pixel electrode group, the second sub-pixel electrode group, and the third sub-pixel electrode group. The display color of the first electrochromic layers includes any one of red (R), green (G), and blue (B). The display color of the second electrochromic layers includes any one of red, green, and blue different from that of the first electrochromic layers. The display color of the third electrochromic layers includes any one of red, green, and blue different from that of the first electrochromic layers and the second electrochromic layers.

In one embodiment, as shown in FIG. 8, the display color of the first electrochromic layers 23 is red, the display color of the second electrochromic layers 24 is green, and the display color of the third electrochromic layers 25 is blue.

Specifically, the preset positive voltage may be applied according to the quality of the finished film, including one or more of a cyclic voltammetry, a non-linear cyclic voltammetry, a constant voltage method, a constant current method, a chronocoulometry method, a pulse voltage method, and a pulse current method.

Specifically, in the electrochemical polymerization, polymers may diffuse to and grow on the edge, in addition to growing on the working electrode in a vertical direction. Therefore, it is necessary to perform negative pressure protection on regions in which other sub-pixel electrode groups are located, so as to prevent the polymers from diffusing to the other sub-pixel electrode groups, when the electrochromic layers with any display color are fabricated. Certainly, in order to avoid growth of polymers on the other sub-pixel electrode groups other than the working electrode in the electrochemical polymerization, a spacing between two adjacent sub-pixel electrodes may be controlled to be a safe spacing, or a partition wall may be provided between two adjacent sub-pixel electrodes. In order to improve an aperture ratio of pixels, it is preferable to protect the other sub-pixel electrode groups by the negative pressure protection process when the polymers are polymerized on any one of the sub-pixel electrode groups to form the corresponding electrochromic layer. Therefore, it is possible to avoid the polymerization occurring on the other sub-pixel electrode groups except the working electrode.

Specifically, step S102 includes steps S1021 to S1024.

S1021: preparing a first electrolyte, a second electrolyte, and a third electrolyte, wherein the first electrolyte comprises a first electrochromic monomer, the second electrolyte comprises a second electrochromic monomer, and the third electrolyte comprises a third electrochromic monomer.

Specifically, each of the first electrolyte, the second electrolyte, and the third electrolyte comprises an initial electrolyte. The initial electrolyte comprises any one of a solute-solvent-based electrolyte, a molten salt-based electrolyte, and an ionic liquid-based electrolyte. For example, the initial electrolyte is an aqueous electrolyte containing an acid and a base, or an aqueous electrolyte into which an inorganic salt (or an organic salt) is dissolved, or an organic solvent electrolyte and an ionic liquid.

Specifically, each of the first electrochromic monomer, the second electrochromic monomer, and the third electrochromic monomer is dissolved in the initial electrolyte.

Specifically, a material of any one of the first electrochromic monomer, the second electrochromic monomer, and the third electrochromic monomer includes at least one of homopolymers of aniline, pyrrole, pyridine, anthraquinone, styrene, pyran, oxazine, thiophene, thiopyran, triphenylamine, pyrazoline, phenazine, and phenoxazine, a derivative or an analogue of the homopolymers, and a copolymer of two or more of aniline, pyrrole, pyridine, anthraquinone, styrene, pyran, oxazine, thiophene, thiopyran, triphenylamine, pyrazoline, phenazine, and phenoxazine. For example, the material of any one of the first electrochromic monomer, the second electrochromic monomer, and the third electrochromic monomer includes a homopolymer formed by any one of the above-listed monomers, or a copolymer formed by any two or more of the above-listed monomers.

In one embodiment, step S1021 comprises the steps of:
dissolving tetrabutylammonium hexafluorophosphate in acetonitrile at a concentration of 0.1 mol/L as the initial electrolyte; and
dissolving monomer R, monomer G, and monomer B in the initial electrolyte at a concentration of 1 mol/L, respectively, and preparing a first electrolyte containing the monomer R, a second electrolyte containing the monomer G, and a third electrolyte containing the monomer B.

The monomer R is 3,3-bishexyloxy-(3,4-propylenedioxythiophene)-3,4-di-

(2-ethylhexyloxy)thiophene, the monomer G is 2,3-bis(4-tert-butylphenyl)-5,8-(2,3-dihydrothieno [3,4-h][1,4]dioxin-7-yl)quinoxaline, and the monomer B is 3,3-bismethoxy-(3,4-propylenedioxythiophene)-(3,4-ethylenedioxythiophene). The specific molecular structures of the monomer R, monomer G, and monomer B are as follows:

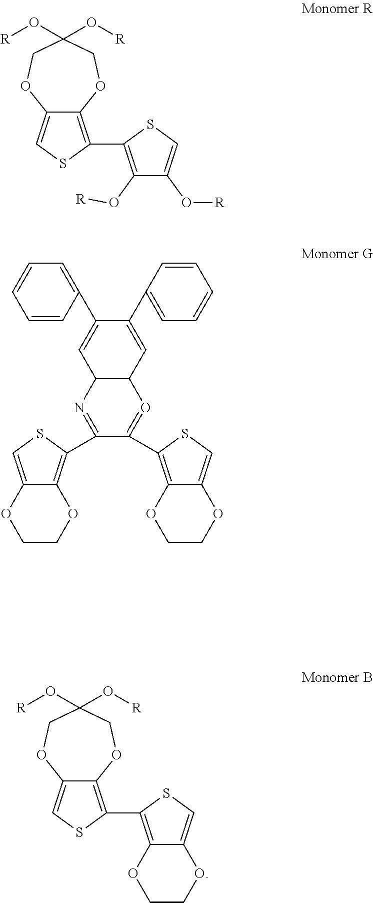

It is to be understood that the monomer R is the first electrochromic monomer, the monomer G is the second electrochromic monomer, and the monomer B is the third electrochromic monomer.

Specifically, the first electrolyte, the second electrolyte, and the third electrolyte further comprise at least one of a surfactant, a plasticizer, and a leveling agent, for assisting in improving the film forming property, the compactness, and the binding force with the electrodes of films, and the like.

S1022: constructing a first electrode system by using the first sub-pixel electrode group in the array substrate as the working electrode, placing the first electrode system into the first electrolyte to perform a first electrochemical polymerization, and forming the first electrochromic layers on the first sub-pixel electrode group.

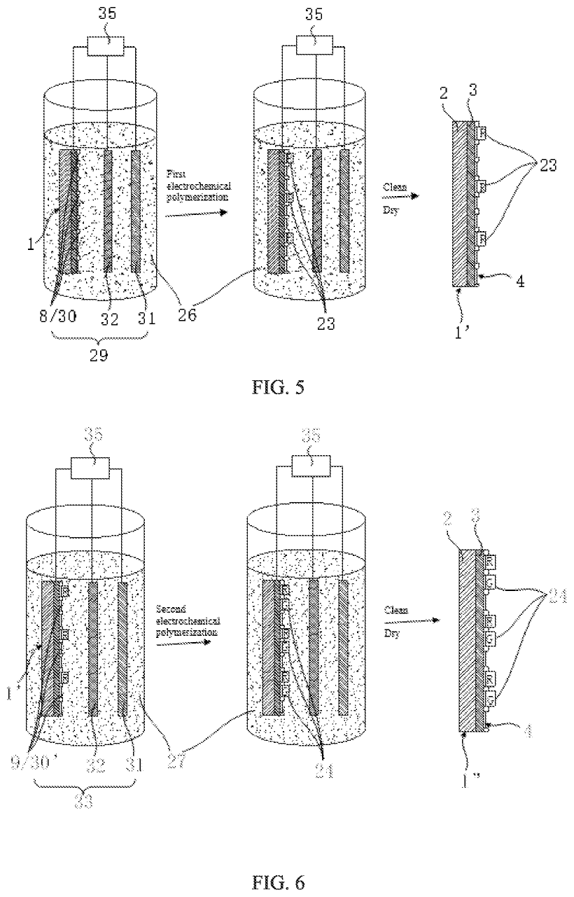

As shown in FIG. 5, all of the first sub-pixel electrodes 8 in the first sub-pixel electrode group in the array substrate 1, as the working electrode 30, are used to construct the first electrode system 29. The first electrode system 29 is placed into the first electrolyte 26 to perform the first electrochemical polymerization, thereby forming the first electrochromic layer 23 on each of the first sub-pixel electrodes 8.

Specifically, as shown in FIG. 5, the first electrode system 29 is a three-electrode system including the working electrode 30, a counter electrode 31, and a reference electrode 32. The counter electrode 31 includes, but is not limited to, any one of a gold electrode, a silver electrode, a platinum electrode, and an indium tin oxide (ITO) electrode. The reference electrode 32 includes, but is not limited to, any one of a silver-silver chloride electrode and a calomel electrode.

In one embodiment, an ITO electrode having the same size as the array substrate 1 is used as the counter electrode 31, and a silver-silver chloride electrode is used as the reference electrode 32.

Specifically, before the first electrochemical polymerization is performed, the first voltage-applying terminal of the array substrate 1, the counter electrode 31, and the reference electrode 32 are electrically connected to three electrode ports of an electrochemical workstation 35 in one-to-one correspondence, respectively. By this configuration, the preset positive voltage is applied between the first voltage-applying terminal (or the first sub-pixel electrodes 8) and the counter electrode 31.

Specifically, the preset positive voltage is an operating voltage of the working electrode 30. The preset positive voltage is greater than 0 V and less than or equal to 5 V, but is not limited thereto.

Specifically, before the first electrochemical polymerization is performed, it is further necessary to apply the preset negative voltage on the second voltage-applying terminal and the third voltage-applying terminal in the array substrate, so as to avoid a polymerization on the second sub-pixel electrodes and the third sub-pixel electrodes during the first electrochemical polymerization. In one embodiment, the second voltage-applying terminal and the third voltage-applying terminal in the array substrate may be connected to the negative electrode of a stabilized voltage supply, and the counter electrode may be connected to the positive electrode of the stabilized voltage supply. The preset negative voltage applied by the stabilized voltage supply is greater than or equal to −1V and less than 0 V, but is not limited thereto.

It is to be noted that the sub-pixels described in the present disclosure may be considered as electrochromic layers located on the sub-pixel electrodes.

It is to be understood that applying of the preset negative voltage on the second voltage-applying terminal and the third voltage-applying terminal is equivalent to applying of the preset negative voltage on the second sub-pixel electrode group and the third sub-pixel electrode group.

It is to be understood that, all of the first sub-pixel electrodes in the first sub-pixel electrode group are electrically connected to the same first voltage-applying terminal, and all of the first sub-pixel electrodes receive the same preset positive voltage, so that the first electrochromic layers formed on all of the first sub-pixel electrodes have the same size and thickness. That is, uniform first electrochromic layers can be obtained. Moreover, since the number of the first sub-pixel electrodes is not limited, it is advantageous to manufacture the first electrochromic layers with large area.

Specifically, as shown in FIG. 5, after completion of the first electrochemical polymerization, the first electrochromic layer 23, such as an electrochromic layer for displaying red (R), is formed on each of the first sub-pixel electrodes 8. At this time, it is necessary to clean the array substrate 1′ with an appropriate solvent to remove oligomer and electrolyte attached to the surface of array substrate 1′. Then, the first electrochromic layers 23 in the form of a thin film are dried (for example, at a temperature of 200° C. for 5 minutes) for preparing the second electrochromic layers in the next stage. The selection of the solvent may follow the polarity of the electrolyte solvent, and an appropriate solvent with a relatively low boiling point, for example, common organic solvents, such as ketones, alcohols, aldehydes, and phenols, and deionized water may be selected.

S1023: Constructing a second electrode system by using the second sub-pixel electrode group in the array substrate formed with the first electrochromic layers as the working electrode, placing the second electrode system into the second electrolyte to perform a second electrochemical polymerization, and forming the second electrochromic layers on the second sub-pixel electrode group.

As shown in FIG. 6, all of the second sub-pixel electrodes 9 in the array substrate 1′ formed with the first electrochromic layers, as the working electrode 30′, are used to construct the second electrode system 33. The second electrode system 33 is placed into the second electrolyte 27 to perform the second electrochemical polymerization, thereby forming the second electrochromic layer 24 on each of the second sub-pixel electrodes 9.

Specifically, as shown in FIG. 6, the second electrode system 33 is a three-electrode system. The materials of the counter electrode and the reference electrode of the second electrode system 33 may be same as or different from that of the first electrode system.

Specifically, before the second electrochemical polymerization is performed, the second voltage-applying terminal in the array substrate 1′, the counter electrode 31, and the reference electrode 32 are electrically connected to the three electrode ports of the electrochemical workstation 35 in one-to-one correspondence, respectively. By this configuration, the preset positive voltage is applied between the second voltage-applying terminal (or the second sub-pixel electrodes 9) and the counter electrode 31.

Specifically, the preset positive voltage is greater than 0 V and less than or equal to 5 V, but is not limited thereto.

Specifically, before the second electrochemical polymerization is performed, it is further necessary to apply the preset negative voltage on the first voltage-applying terminal and the third voltage-applying terminal in the array substrate, so as to avoid a polymerization on the first sub-pixel electrodes and the third sub-pixel electrodes during the second electrochemical polymerization. In one embodiment, the first voltage-applying terminal and the third voltage-applying terminal in the array substrate may be connected to the negative electrode of a stabilized voltage supply, and the counter electrode may be connected to the positive electrode of the stabilized voltage supply. The preset negative voltage applied by the stabilized voltage supply is greater than or equal to −1V and less than 0 V, but is not limited thereto.

It is to be understood that applying of the preset negative voltage on the first voltage-applying terminal and the third voltage-applying terminal is equivalent to applying of the preset negative voltage on the first sub-pixel electrode group and the third sub-pixel electrode group.

It is to be understood that all of the second sub-pixel electrodes in the second sub-pixel electrode group are electrically connected to the same second voltage-applying terminal, and all of the second sub-pixel electrodes receive the same preset positive voltage, so that the second electrochromic layers formed on all of the second sub-pixel electrodes have the same size and thickness. That is, uniform second electrochromic layers can be obtained. Moreover, since the number of the second sub-pixel electrodes is not limited, it is advantageous to manufacture a second electrochromic layers with large area.

Specifically, as shown in FIG. 6, after completion of the second electrochemical polymerization, the second electrochromic layer 24, for example, an electrochromic layers for displaying green (G), is formed on each of the second sub-pixel electrodes 9. At this time, it is necessary to clean an array substrate 1″ with an appropriate solvent to remove oligomer and electrolyte attached to the surface of array substrate 1″. Then, the second electrochromic layers 24 in the form of a thin film are dried for preparing the third electrochromic layers in the next stage.

S1024: constructing a third sub-pixel electrode system by using the third sub-pixel electrode group in the array substrate formed with the first electrochromic layers and the second electrochromic layers as the working electrode, placing the third electrode system in the third electrolyte to perform a third electrochemical polymerization, and forming the third electrochromic layers on the third sub-pixel electrode group.

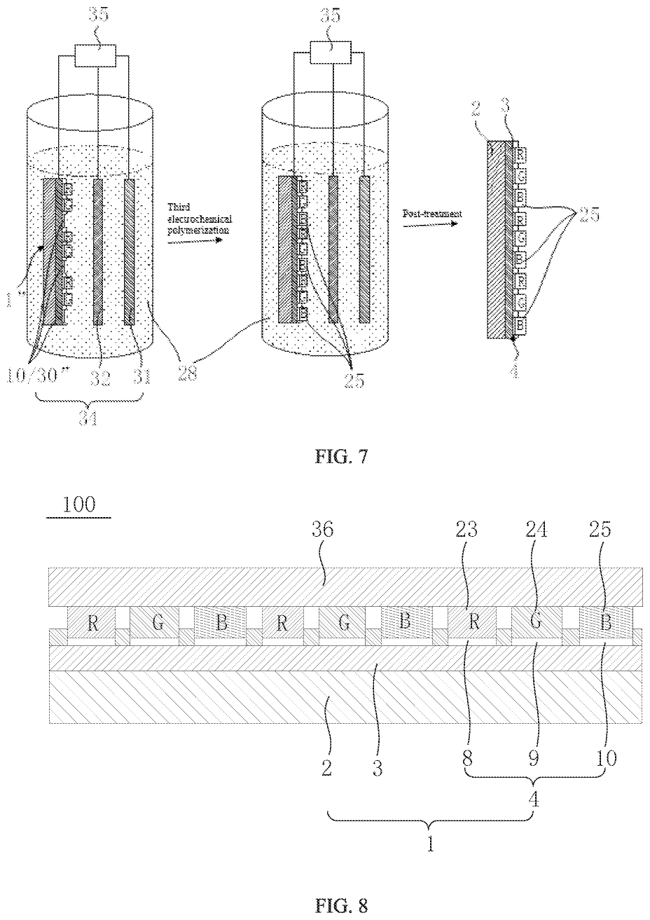

As shown in FIG. 7, all of the third sub-pixel electrodes 10 in the array substrate 1″ formed with the first electrochromic layers and the second electrochromic layers, as the working electrode 30″, are used to construct the third electrode system 34. The third electrode system 34 is placed into the third electrolyte 28 to perform the third electrochemical polymerization, thereby forming the third electrochromic layer 25 on each of the third sub-pixel electrodes 10.

Specifically, the third electrode system 34 is a three-electrode system. The materials of the counter electrode and the reference electrode of the third electrode system 34 may be same as or different from that of the first electrode system and the second electrode system.

Specifically, before the third electrochemical polymerization is performed, the third voltage-applying terminal in the array substrate 1″, the counter electrode 31, and the reference electrode 32 are electrically connected to the three electrode ports of the electrochemical workstation 35 in one-to-one correspondence, respectively. By this configuration, the preset positive voltage is applied between the third voltage-applying terminal (or the third sub-pixel electrodes 10) and the counter electrode 31.

Specifically, the preset positive voltage is greater than 0 V and less than or equal to 5 V, but is not limited thereto.

Specifically, before the third electrochemical polymerization is performed, it is further necessary to apply the preset negative voltage on the first voltage-applying terminal and the second voltage-applying terminal in the array substrate, so as to avoid a polymerization on the first sub-pixel electrodes and the second sub-pixel electrodes during the third electrochemical polymerization. In one embodiment, the first voltage-applying terminal and the second voltage-applying terminal in the array substrate may be connected to the negative electrode of a stabilized voltage supply, and the counter electrode may be connected to the positive electrode of the stabilized voltage supply. The preset negative voltage applied by the stabilized voltage supply is greater than or equal to −1V and less than 0 V, but is not limited thereto.

It is to be understood that applying of the preset negative voltage on the first voltage-applying terminal and the second voltage-applying terminal is equivalent to applying of the preset negative voltage on the first sub-pixel electrode group and the second sub-pixel electrode group.

It is to be understood that all of the third sub-pixel electrodes in the third sub-pixel electrode group are electrically connected to the same third voltage-applying terminal, and all of the third sub-pixel electrodes receive the same preset positive voltage, so that the third electrochromic layers formed on all of the third sub-pixel electrodes have the same size and thickness. That is, uniform third electrochromic layers can be obtained. Since the number of the third sub-pixel electrodes is not limited, it is advantageous to manufacture third electrochromic layers with large area.

Specifically, as shown in FIG. 7, after completion of the third electrochemical polymerization, the third electrochromic layer 25, such as an electrochromic layer for displaying blue (B), is formed on each of the third sub-pixel electrodes 10. At this time, it is necessary to perform post-treatment for the grown polymers (the first electrochromic layers, the second electrochromic layers, and the third electrochromic layers), including but not limited to common post-treatment methods such as a heating treatment, an immersion in acid solution, and an immersion in surfactant. The post-treatment serves to flatten the film surface, improve the hydrophilic and hydrophobic properties of the film surface, and improve the binding force of the polymer film to the substrate. It is to be noted that the post-treatment should be carried out without physical or chemical reaction with the array substrate and without loss of photoelectric performance of the array substrate.

Specifically, an electrochemical window of polymerization voltage in the initial electrolyte of the first electrolyte, the second electrolyte, or the third electrolyte is larger than any one of a voltage of the first electrochemical polymerization, a voltage of the second electrochemical polymerization, and a voltage of the third electrochemical polymerization voltage.

Specifically, the preparation order of the electrochromic layers for displaying red, the electrochromic layers for displaying green, and the electrochromic layers for displaying blue is not limited, and the polymerization order of the three can be adjusted according to the quality of the finished film and the selection of the lotion.

Specifically, the preset positive voltage is applied to the first electrochemical polymerization, the second electrochemical polymerization, and the third electrochemical polymerization by a cyclic voltammetry, with a cycle range including 0 V to 5 V, a sweep speed range including 1 mV/s to 100 mV/s, and the number of cycles including 1 cycle to 100 cycles.

Specifically, when the first electrochemical polymerization, the second electrochemical polymerization, and the third electrochemical polymerization are performed, the gate electrodes of the thin film transistors in the array substrate are turned on, so that the first voltage-applying terminal, the second voltage-applying terminal, and the third voltage-applying terminal are in one-to-one correspondence electrically communicated with the first sub-pixel electrode group, the second sub-pixel electrode group, and the third sub-pixel electrode group, respectively. Therefore, the preset positive voltage or the preset negative voltage applied to the first voltage-applying terminal, the second voltage-applying terminal, and the third voltage-applying terminal may be successfully transferred to the corresponding sub-pixel electrode group.

Specifically, after all of the first electrochromic layers, the second electrochromic layers, and the third electrochromic layers have been deposited, it is further necessary to pressurize all sub-pixel regions and test performance thereof.

Step S103: Forming an opposing substrate on sides of the plurality of electrochromic layers far away from the array substrate.

Specifically, as shown in FIG. 8, the opposing substrate 36 is formed on sides of the plurality of electrochromic layers (including the first electrochromic layers 23, the second electrochromic layers 24, and the third electrochromic layers 25) away from the array substrate 1 to obtain the electrochromic display panel 100.

Specifically, the opposing substrate is a transparent substrate, and specifically includes a base substrate and a common electrode layer (not shown) disposed on a side of the base substrate adjacent to the electrochromic layer.

In one embodiment, after the opposing substrate is formed, the non-display region in which the voltage-applying terminal is located may be cut off to narrow the frame of the electrochromic display panel.

It is to be understood that, when the first electrochromic layers, the second electrochromic layers, and the third electrochromic layers are fabricated, the thin film transistors in the array substrate are used to transfer the preset positive voltage (for the polymerization) and/or the preset negative voltage (for the negative voltage protection process) to the first sub-pixel electrodes, the second sub-pixel electrodes, and the third sub-pixel electrodes. After the fabrication of the electrochromic display panel is completed, the thin film transistors in the array substrate are used to transmit a source electrode electric signal for displaying to the first sub-pixel electrodes, the second sub-pixel electrodes, and the third sub-pixel electrodes.

It is to be understood that the electrochromic display panel prepared in the embodiments herein can display RGB three-primary colors.

It is to be noted that, since electrochromic materials themselves cannot emit light actively, the colors displayed by the electrochromic layers are realized through the absorption of different bands of visible light in ambient light by the electrochromic materials. Therefore, the display mode of the electrochromic display panel manufactured in the embodiments of the present disclosure belongs to inactive light-emitting display, that is, passive display.

It is to be understood that the electrochromic materials in the embodiments of the present disclosure may be selected as a transparent pigment, but is not limited thereto. The formed electrochromic layers display colors under the action of an electric field applied to the array substrate and the opposing substrate. For example, at different voltages, the first electrochromic layers, the second electrochromic layers, and the third electrochromic layers may be changed from a transparent state to red, green, and blue, respectively, and the chromaticity and transmittance of the colors is related to the applied voltage with respect to gray scales. Thus, transparent electrochromic display devices are also within the scope of the present disclosure.

In the embodiments of the present disclosure, the plurality of electrochromic layers (for example, the first electrochromic layers 23, the second electrochromic layers 24, and the third electrochromic layers 25) are sequentially formed on the plurality of sub-pixel electrode groups (for example, the first sub-pixel electrode group 5, the second sub-pixel electrode group 6, and the third sub-pixel electrode group 7) in the array substrate 1 by electrochemical polymerization, and disposed in one-to-one correspondence with the plurality of sub-pixel electrode groups. The plurality of electrochromic layers disposed in one-to-one correspondence with the plurality of sub-pixel electrode groups display different colors. Further, when the electrochromic layers are formed by polymerization on any one corresponding sub-pixel electrode group, the preset negative voltage is applied other sub-pixel electrode groups to protect them, so that the polymerization is prevented from occurring on the other sub-pixel electrode groups except the working electrode. In one aspect, the present disclosure can produce the plurality of electrochromic layers of uniform thickness, large area, pixel-level patterning, and different display colors (e.g., RGB) by a combination of the electrochemical polymerization and the negative pressure protection. On the other hand, the electrochemical polymerization process is adapted to the array substrate 1 of the present disclosure, that is, the monochromatic sub-pixel electrode groups in the array substrate 1 are directly subjected to deposition of monochromatic electrochromic layers. Therefore, this achieves the advantages of high process matching degree and decreasing the process steps. Moreover, due to the relatively strong ability of the polymers to grow in a predetermined region, it is advantageous to prepare the electrochromic display panel with high PPI (Pixel Density). On the other hand, the electrochromic layers with different display colors (e.g., RGB) can be subjected to ON/OFF control of single sub-pixel by the TFT of the array substrate 1, and further to gray scale control by changing grid voltage of the TFT of the driving layer 3, thereby realizing the electrochromic passive display technology.

As shown in FIG. 8, an embodiment of the present disclosure provides an electrochromic display panel 100 manufactured according to the manufacturing method of the foregoing embodiments.

Specifically, the electrochromic display panel 100 includes an array substrate 1 and an opposing substrate 36 that are oppositely disposed, and a plurality of electrochromic layers (e.g., the first electrochromic layers 23, the second electrochromic layers 24, and the third electrochromic layers 25) disposed between the array substrate 1 and the opposing substrate 36.

Specifically, specific structures of the array substrate 1, the opposing substrate 36, and the plurality of electrochromic layers may refer to the description of foregoing embodiments, and details are not described herein.

Specifically, under the absorption and transmission of different visible bands of ambient light by the electrochromic materials in the plurality of electrochromic layers, the electrochromic display panel can display RGB three-primary colors. Therefore, the display mode of the electrochromic display panel provided in the embodiments of the present disclosure belongs to an inactive light-emitting display, i.e. a passive display.

Specifically, the electrochromic material in the embodiments of the present disclosure may be selected as a transparent pigment, but is not limited thereto. The formed electrochromic layers display colors under the action of an electric field applied to the array substrate and the opposing substrate. For example, at different voltages, the first electrochromic layers, the second electrochromic layers, and the third electrochromic layers may be changed from the transparent state to red, green, and blue, respectively, and the chromaticity of colors and transmittance is related to the applied voltage with regard to gray-scales.

In the embodiment, since each electrochromic layer is fabricated on a corresponding sub-pixel electrode by the electrochemical polymerization process and the negative pressure protection process, the plurality of electrochromic layers displaying different colors (e.g., RGB) have the advantages of uniform thickness, large area, and pixel-level patterning. Furthermore, due to the relatively strong ability of the polymers to grow in a predetermined region, it is advantageous to improve the PPI of the electrochromic display panel. In addition, the electrochromic layers with different display colors can be subjected to ON/OFF control by the TFT of the array substrate, and further to gray scale control by changing grid voltage of the TFT of the driving layer, thereby realizing the electrochromic passive display technology.

The above embodiments of the present disclosure describe the method of manufacturing the electrochromic display panel and the electrochromic display panel in detail. Specific examples are used herein to illustrate the principles and implementation of the present disclosure. The description of the above embodiments is merely intended to help understand the technical solutions and the core idea of the present disclosure. It is to be understood by those of ordinary skill in the art that it is still possible to modify the technical solutions described in the preceding examples, or to substitute some of the technical features with equivalent ones. These modifications or substitutions do not depart the essence of the corresponding technical solutions from the scope of the technical solutions of the present disclosure.

What is claimed is:

1. A method of manufacturing an electrochromic display panel, comprising steps of:
manufacturing an array substrate, wherein the array substrate comprises a base substrate, and a driving layer and a pixel electrode layer sequentially disposed on the base substrate; and the pixel electrode layer comprises a plurality of sub-pixel electrode groups disposed at intervals and electrically connected to the driving layer; and
forming a plurality of electrochromic layers disposed in one-to-one correspondence with the plurality of sub-pixel electrode groups by electrochemical polymerization using each of the plurality of sub-pixel electrode groups as a working electrode in sequence, wherein the electrochromic layers corresponding to different sub-pixel electrode groups have different display colors, and when any one of the plurality of sub-pixel electrode groups is used as the working electrode, a preset positive voltage is applied to the working electrode to form corresponding electrochromic layers on the working electrode.

2. The method of manufacturing the electrochromic display panel according to claim 1, wherein when any one of the plurality of sub-pixel electrode groups is used as the working electrode, a preset negative voltage is applied to other sub-pixel electrode groups.

3. The method of manufacturing the electrochromic display panel according to claim 1, wherein the plurality of sub-pixel electrode groups comprise a first sub-pixel electrode group, a second sub-pixel electrode group, and a third sub-pixel electrode group; the plurality of electrochromic layers comprise first electrochromic layers, second electrochromic layers, and third electrochromic layers respectively disposed in one-to-one correspondence with the first sub-pixel electrode group, the second sub-pixel electrode group, and the third sub-pixel electrode group;
a display color of the first electrochromic layers comprises any one of red, green, and blue; a display color of the second electrochromic layers comprises any one of red, green, and blue different from that of the first electrochromic layers; a display color of the third electrochromic layers comprises any one of red, green, and blue different from those of the first electrochromic layers and the second electrochromic layers.

4. The method of manufacturing the electrochromic display panel according to claim 3, wherein the step of forming the plurality of electrochromic layers disposed in one-to-one correspondence with the plurality of sub-pixel electrode groups by electrochemical polymerization using each of the plurality of sub-pixel electrode groups as the working electrode in sequence, comprises following steps:
preparing a first electrolyte, a second electrolyte, and a third electrolyte, wherein the first electrolyte comprises a first electrochromic monomer, the second electrolyte comprises a second electrochromic monomer, and the third electrolyte comprises a third electrochromic monomer;
constructing a first electrode system by using the first sub-pixel electrode group in the array substrate as the working electrode, placing the first electrode system into the first electrolyte, performing a first electrochemical polymerization, and forming the first electrochromic layers on the first sub-pixel electrode group;
constructing a second electrode system by using the second sub-pixel electrode group in the array substrate provided with the first electrochromic layers as the working electrode, placing the second electrode system into the second electrolyte, performing a second electrochemical polymerization, and forming the second electrochromic layers on the second sub-pixel electrode group; and
constructing a third electrode system by using the third sub-pixel electrode group in the array substrate provided with the first electrochromic layers and the second electrochromic layers as the working electrode, placing the third electrode system into the third electrolyte, performing a third electrochemical polymerization, and forming the third electrochromic layers on the third sub-pixel electrode group.

5. The method of manufacturing the electrochromic display panel according to claim 4, wherein any one of the first electrode system, the second electrode system, and the third electrode system comprises a three-electrode system, and wherein the three-electrode system comprises the working electrode, a counter electrode, and a reference electrode; the counter electrode comprises any one of a gold electrode, a silver electrode, a platinum electrode, and an indium tin oxide electrode; the reference electrode comprises any one of a silver-silver chloride electrode and a calomel electrode.

6. The method of manufacturing the electrochromic display panel according to claim 4, wherein a material of any one of the first electrochromic monomer, the second electrochromic monomer, and the third electrochromic monomer comprises at least one of homopolymers of aniline, pyrrole, pyridine, anthraquinone, styrene, pyran, oxazine, thiophene, thiopyran, triphenylamine, pyrazoline, phenazine, and phenoxazine, a derivative or an analogue of the homopolymers, and a copolymer of two or more of aniline, pyrrole, pyridine, anthraquinone, styrene, pyran, oxazine, thiophene, thiopyran, triphenylamine, pyrazoline, phenazine, and phenoxazine.

7. The method of manufacturing the electrochromic display panel according to claim 3, wherein the electrochromic display panel has a display region and a non-display region adjacent to the display region; the pixel electrode layer is located in the display region;
the driving layer comprises a first connection wiring group, a second connection wiring group, and a third connection wiring group located in the display region, and a first voltage-applying terminal, a second voltage-applying terminal, and a third voltage-applying terminal located in the non-display region; the first connection wiring group is electrically connected to the first sub-pixel electrode group, and extends to the non-display region to electrically connect to the first power-on terminal; the second connection wiring group is electrically connected to the second sub-pixel electrode group, and extends to the non-display region to electrically connect to the second power-on terminal; the third connection wiring group is electrically connected to the third sub-pixel electrode group, and extends to the non-display region to electrically connect to the third power-on terminal; and
any one of the first voltage-applying terminal, the second voltage-applying terminal, and the third voltage-applying terminal is applied with the preset positive voltage.

8. The method of manufacturing the electrochromic display panel according to claim 7, wherein the first sub-pixel electrode group comprises a plurality of first sub-pixel electrodes arranged in multiple columns; the second sub-pixel electrode group comprises a plurality of second sub-pixel electrodes arranged in multiple columns; the third sub-pixel electrode group comprises a plurality of third sub-pixel electrodes arranged in multiple columns; and
the first connection wiring group comprises a plurality of first source lines electrically connected in one-to-one correspondence with the multiple columns of the first sub-pixel electrodes; the second connection wiring group comprises a plurality of second source lines electrically connected in one-to-one correspondence with the multiple columns of the second sub-pixel electrodes; the third connection wiring group comprises a plurality of third source lines electrically connected in one-to-one correspondence with the multiple columns of the third sub-pixel electrodes.

9. The method of manufacturing the electrochromic display panel according to claim 8, wherein the driving layer further comprises a plurality of thin film transistors located in the display region and electrically connected in one-to-one correspondence with the plurality of first sub-pixel electrodes, the plurality of second sub-pixel electrodes, and the plurality of third sub-pixel electrodes;
source electrodes of the thin film transistors electrically connected to the first sub-pixel electrodes are electrically connected to the corresponding first source lines, source electrodes of the thin film transistors electrically connected to the second sub-pixel electrodes are electrically connected to the corresponding second source lines, and source electrodes of the thin film transistors electrically connected to the third sub-pixel electrodes are electrically connected to the corresponding third source lines; and
the first voltage-applying terminal, the second voltage-applying terminal, and the third voltage-applying terminal are disposed in a same layer and of same materials as gate electrodes of the thin film transistors.

10. An electrochromic display panel, comprising:
an array substrate, wherein the array substrate comprises a base substrate, and a driving layer and a pixel electrode layer sequentially disposed on the base substrate; and the pixel electrode layer comprises a plurality of sub-pixel electrode groups disposed at intervals and electrically connected to the driving layer; and
a plurality of electrochromic layers disposed in one-to-one correspondence with the plurality of sub-pixel electrode groups, wherein the plurality of electrochromic layers are formed by electrochemical polymerization using each of the plurality of sub-pixel electrode groups as a working electrode in sequence, wherein the electrochromic layers corresponding to different sub-pixel electrode groups have different display colors, and when any one of the plurality of sub-pixel electrode groups is used as the working electrode, a preset positive voltage is applied to the working electrode to form corresponding electrochromic layers on the working electrode.

11. The electrochromic display panel according to claim 10, wherein when any one of the plurality of sub-pixel electrode groups is used as the working electrode, a preset negative voltage is applied to other sub-pixel electrode groups.

12. The electrochromic display panel according to claim 10, wherein the plurality of sub-pixel electrode groups comprise a first sub-pixel electrode group, a second sub-pixel electrode group, and a third sub-pixel electrode group; the plurality of electrochromic layers comprise first electrochromic layers, second electrochromic layers, and third electrochromic layers respectively disposed in one-to-one correspondence with the first sub-pixel electrode group, the second sub-pixel electrode group, and the third sub-pixel electrode group;
a display color of the first electrochromic layers comprises any one of red, green, and blue; a display color of the second electrochromic layers comprises any one of red, green, and blue different from that of the first electrochromic layers; a display color of the third electrochromic layers comprises any one of red, green, and blue different from those of the first electrochromic layers and the second electrochromic layers.

13. The electrochromic display panel according to claim 12, wherein the first electrochromic layers comprises polymers of a first electrochromic monomer, the second electrochromic layers comprises polymers of a second electrochromic monomer, and the first electrochromic layers comprises polymers of a third electrochromic monomer.

14. The electrochromic display panel according to claim 13, wherein a material of any one of the first electrochromic monomer, the second electrochromic monomer, and the third electrochromic monomer comprises at least one of homopolymers of aniline, pyrrole, pyridine, anthraquinone, styrene, pyran, oxazine, thiophene, thiopyran, triphenylamine, pyrazoline, phenazine, and phenoxazine, a derivative or an analogue of the homopolymers, and a copolymer of two or more of aniline, pyrrole, pyridine, anthraquinone, styrene, pyran, oxazine, thiophene, thiopyran, triphenylamine, pyrazoline, phenazine, and phenoxazine.

15. The electrochromic display panel according to claim 10, wherein the electrochromic display panel has a display region and a non-display region adjacent to the display region; the pixel electrode layer is located in the display region;
the driving layer comprises a first connection wiring group, a second connection wiring group, and a third connection wiring group located in the display region, and a first voltage-applying terminal, a second voltage-applying terminal, and a third voltage-applying terminal located in the non-display region; the first connection wiring group is electrically connected to the first sub-pixel electrode group, and extends to the non-display region to electrically connect to the first power-on terminal; the second connection wiring group is electrically connected to the second sub-pixel electrode group, and extends to the non-display region to electrically connect to the second power-on terminal; the third connection wiring group is electrically connected to the third sub-pixel electrode group, and extends to the non-display region to electrically connect to the third power-on terminal; and
any one of the first voltage-applying terminal, the second voltage-applying terminal, and the third voltage-applying terminal is applied with the preset positive voltage.

16. The electrochromic display panel according to claim 15, wherein the first sub-pixel electrode group comprises a plurality of first sub-pixel electrodes arranged in multiple columns; the second sub-pixel electrode group comprises a plurality of second sub-pixel electrodes arranged in multiple columns; the third sub-pixel electrode group comprises a plurality of third sub-pixel electrodes arranged in multiple columns; and
the first connection wiring group comprises a plurality of first source lines electrically connected in one-to-one correspondence with the multiple columns of the first sub-pixel electrodes; the second connection wiring group comprises a plurality of second source lines electrically connected in one-to-one correspondence with the multiple columns of the second sub-pixel electrodes; the third connection wiring group comprises a plurality of third source lines electrically connected in one-to-one correspondence with the multiple columns of the third sub-pixel electrodes.

17. The electrochromic display panel according to claim 15, wherein the driving layer further comprises a plurality of thin film transistors located in the display region and electrically connected in one-to-one correspondence with the plurality of first sub-pixel electrodes, the plurality of second sub-pixel electrodes, and the plurality of third sub-pixel electrodes;
source electrodes of the thin film transistors electrically connected to the first sub-pixel electrodes are electrically connected to the corresponding first source lines, source electrodes of the thin film transistors electrically connected to the corresponding second sub-pixel electrodes are electrically connected to the second source lines, and source electrodes of the thin film transistors electrically connected to the corresponding third sub-pixel electrodes are electrically connected to the third source lines; and
the first voltage-applying terminal, the second voltage-applying terminal, and the third voltage-applying terminal are disposed in a same layer and of same materials as gate electrodes of the thin film transistors.

18. The electrochromic display panel according to claim 10, further comprising an opposing substrate on sides of the plurality of electrochromic layers away from the array substrate.
